(19) United States
(12) Patent Application Publication
(10) Pub. No.: US 2015/0127703 A1
(43) Pub. Date: May 7, 2015

(54) NAME BASED MEDIA DELIVERY AND PRESENTATION SYSTEM

(71) Applicant: Samsung Electronics Co., Ltd., Suwon-si (KR)

(72) Inventor: Youngkwon Lim, Allen, TX (US)

(21) Appl. No.: 14/527,456

(22) Filed: Oct. 29, 2014

Related U.S. Application Data
(60) Provisional application No. 61/898,274, filed on Oct. 31, 2013.

(51) Int. Cl. H04L 29/08; H04L 29/06

(52) U.S. Cl. CPC H04L 67/10; H04L 65/60
USPC 709/201

(57) ABSTRACT

An electronic device is provided. The electronic device includes a media communication system. The media communication system is configured to receive presentation information identifying a multimedia name. The media communication system is also configured to receive one or more multimedia data units associated with the multimedia name. The media communication system is further configured to configure the one or more multimedia data units associated with the multimedia name for a presentation.

### CROSS-REFERENCE TO RELATED APPLICATION(S) AND CLAIM OF PRIORITY

The present application claims priority to U.S. Provisional Patent Application Ser. No. 61/898,274, filed Oct. 31, 2013, entitled “NAME BASED MEDIA DELIVERY AND PRESENTATION SYSTEM”. The content of the above-identified patent document is incorporated herein by reference.

### TECHNICAL FIELD

The present application relates generally to multimedia presentations and, more specifically, to facilitating name-based media delivery and presentation.

### BACKGROUND

Previous multimedia communication systems are designed based on two principles. Presentation layer in charge of establishing connection to receive the media data and instantiate the decoder. Such a system is inefficient and lacks flexibility when the client has multiple connection choices including local storage or cache and when each connection offers multiple version of content with various compression types. Previous multimedia communication systems cannot effectively and efficiently utilize the benefits of having multiple data connections of modern devices including local storages and powerful software based environments which do not have restrictions to supporting various compression technologies and dynamic coding configuration changes.

### SUMMARY

In a first embodiment, electronic device is provided. The electronic device includes a media communication system. The media communication system is configured to receive presentation information identifying a multimedia name. The media communication system is also configured to receive one or more multimedia data units associated with the multimedia name. The media communication system is further configured to configure the one or more multimedia data units associated with the multimedia name for a presentation.

In a second embodiment, a media communication system of an electronic device is provided. The system includes a presentation layer. The presentation layer is configured to receive presentation information and configure multimedia data units for a presentation. The presentation information identifies a multimedia name. The system also includes a delivery layer. The delivery layer is configured to receive one or more multimedia data units associated with the multimedia name. The system further includes a codec layer. The codec layer is configured to decode the one or more multimedia data units received by the delivery layer before the multimedia data units are configured for the presentation.

In a third embodiment, a method for use in an electronic device is provided. The method includes receiving presentation information identifying a multimedia name. The method also includes receiving one or more multimedia data units associated with the multimedia name. The method further includes configuring the one or more multimedia data units associated with the multimedia name for a presentation.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to this disclosure;

FIGS. 2A and 2B illustrate example wireless transmit and receive paths according to this disclosure;

FIG. 3 illustrates an example user equipment according to this disclosure;

FIG. 4 illustrates an example diagram of a multimedia communication system according to this disclosure; and

FIG. 5 illustrates a flow diagram of an example method according to this disclosure.

### DETAILED DESCRIPTION

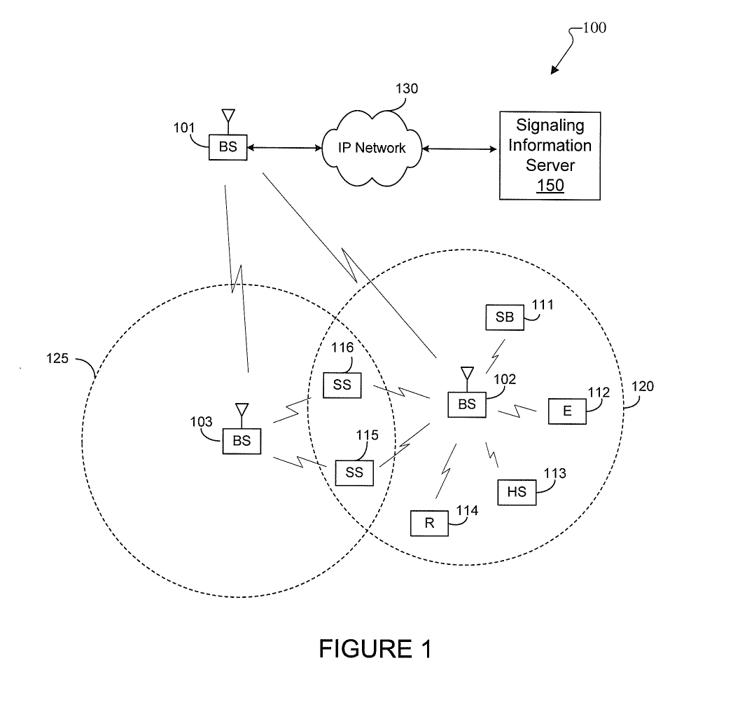

FIGS. 1 through 5, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged electronic device.

FIG. 1 illustrates an example wireless network 100 according to this disclosure. The embodiment of the wireless network 100 shown in FIG. 1 is for illustration only. Other embodiments of the wireless network 100 could be used without departing from the scope of this disclosure.

As shown in FIG. 1, the wireless network 100 includes an eNodeB (eNB) 101, an eNB 102, an eNB 103, and at least one signaling information server 150. The eNB 101 communicates with the eNB 102 and the eNB 103. The eNB 101 also communicates with at least one Internet Protocol (IP) network 130, such as the Internet, a proprietary IP network, or other data network. The eNB 101 communicates with the signaling information server 150 through the at least one Internet Protocol network 130.

Depending on the network type, other well-known terms may be used instead of “eNodeB” or “eNB,” such as “base station” or “access point.” For the sake of convenience, the terms “eNodeB” and “eNB” are used in this patent document to refer to network infrastructure components that provide wireless access to remote terminals. Also, depending on the network type, other well-known terms may be used instead of “user equipment” or “UE,” such as “mobile station,” “subscriber station,” “remote terminal,” “wireless terminal,” or “user device.” For the sake of convenience, the terms “user equipment” and “UE” are used in this patent document to refer to remote wireless equipment that wirelessly accesses an eNB, whether the UE is a mobile device (such as a mobile telephone or smartphone) or is normally considered a stationary device (such as a desktop computer or vending machine).

The eNB 102 provides wireless broadband access to the network 130 for a first plurality of user equipments (UEs) within a coverage area 120 of the eNB 102. The first plurality of UEs includes a UE 111, which may be located in a small business (SB); a UE 112, which may be located in an enterprise (E); a UE 113, which may be located in a WiFi hotspot (HS); a UE 114, which may be located in a first residence (R); a UE 115, which may be located in a second residence (R); and a UE 116, which may be a mobile device (M) like a cell phone, a wireless laptop, a wireless PDA, or the like. The eNB 103 provides wireless broadband access to the network 130 for a second plurality of UEs within a coverage area 125 of the eNB 103. The second plurality of UEs includes the UE 115 and the UE 116. In some embodiments, one or more of the eNBs 101-103 may communicate with each other and with the UEs 111-116 using 5G, LTE, LTE-A, WiMAX, or other advanced wireless communication techniques.

Dotted lines show the approximate extents of the coverage areas 120 and 125, which are shown as approximately circular for the purposes of illustration and explanation only. It should be clearly understood that the coverage areas associated with eNBs, such as the coverage areas 120 and 125, may have other shapes, including irregular shapes, depending upon the configuration of the eNBs and variations in the radio environment associated with natural and man-made obstructions.

The signaling information server 150 is configured to receive and store or index signaling information related to name-based multimedia. Signaling information includes at least three basic items of information: a multimedia data name; one or more locations of such multimedia data, such as one or more different servers or terminals; and one or more methods or channels for accessing such multimedia data, such as internet channels, wireless channels, broadcast channels, or the like. The signaling information server 150 collects signaling information from a plurality of servers and stores signaling information in a storage medium.

For example, the signaling information server 150 obtains the multimedia data names, their locations, and channels by which the multimedia data can be accessed for one or more movies in a plurality of locations. The signaling information server 150 stores the collected signaling information in an index based on the one or more movie names. The signaling server 150 can transmit one or more items of signaling information to a UE, such as UE 116, in response to receiving a request from the UE to obtain name-based multimedia data for one or more particular movies. The signaling server 150 can also transmit the entire index of signaling information to a UE at intermittent times or continuously as the signaling information server 150 generates updates to the signaling information index so that the UE has the signaling information available to obtain to the name-based multimedia. As discussed herein, a UE in a multimedia communication system can use signaling information to obtain named-based multimedia data and content.

As described in more detail below, a multimedia communication system can use the wireless network 100 to facilitate name-based media delivery and presentation to an electronic device. Although FIG. 1 illustrates one example of a wireless network 100, various changes may be made to FIG. 1. For example, the wireless network 100 could include any number of eNBs and any number of UEs in any suitable arrangement. Also, the eNB 101 could communicate directly with any number of UEs and provide those UEs with wireless broadband access to the network 130 as well as access to the signaling information server 150. Similarly, each eNB 102-103 could communicate directly with the network 130 and provide UEs with direct wireless broadband access to the network 130 as well as access to the signaling information server 150. Further, the eNB 101, 102, or 103 could provide access to other or additional external networks, such as external telephone networks or other types of data networks.

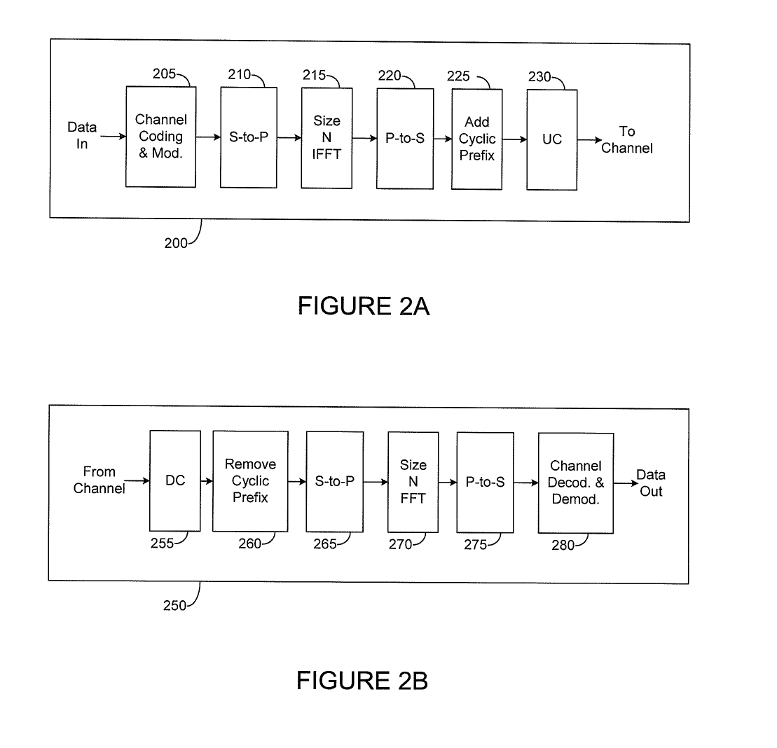

FIGS. 2A and 2B illustrate example wireless transmit and receive paths according to this disclosure. In the following description, a transmit path 200 may be described as being implemented in an eNB (such as eNB 102), while a receive path 250 may be described as being implemented in a UE (such as UE 116). However, it will be understood that the receive path 250 could be implemented in an eNB and that the transmit path 200 could be implemented in a UE. In some embodiments, the transmit path 200 and receive path 250 are configured to transmit requests for name-based media delivery and to receive the name-based media for presentation via an electronic device.

The transmit path 200 includes a channel coding and modulation block 205, a serial-to-parallel (S-to-P) block 210, a size N Inverse Fast Fourier Transform (IFFT) block 215, a parallel-to-serial (P-to-S) block 220, an add cyclic prefix block 225, and an up-converter (UC) 230. The receive path 250 includes a down-converter (DC) 255, a remove cyclic prefix block 260, a serial-to-parallel (S-to-P) block 265, a size N Fast Fourier Transform (FFT) block 270, a parallel-to-serial (P-to-S) block 275, and a channel decoding and demodulation block 280.

In the transmit path 200, the channel coding and modulation block 205 receives a set of information bits, applies coding (such as a low-density parity check (LDPC) coding), and modulates the input bits (such as with Quadrature Phase Shift Keying (QPSK) or Quadrature Amplitude Modulation (QAM)) to generate a sequence of frequency-domain modulation symbols. The serial-to-parallel block 210 converts (such as de-multiplexes) the serial modulated symbols to parallel data in order to generate N parallel symbol streams, where N is the IFFT/FFT size used in the eNB 102 and the UE 116. The size N IFFT block 215 performs an IFFT operation on the N parallel symbol streams to generate time-domain output signals. The parallel-to-serial block 220 converts (such as multiplexes) the parallel time-domain output symbols from the size N IFFT block 215 in order to generate a serial time-domain signal. The add cyclic prefix block 225 inserts a cyclic prefix to the time-domain signal. The up-converter 230 modulates (such as up-converts) the output of the add cyclic prefix block 225 to an RF frequency for transmission via a wireless channel. The signal may also be filtered at baseband before conversion to the RF frequency.

A transmitted RF signal from the eNB 102 arrives at the UE 116 after passing through the wireless channel, and reverse operations to those at the eNB 102 are performed at the UE 116. The down-converter 255 down-converts the received signal to a baseband frequency, and the remove cyclic prefix block 260 removes the cyclic prefix to generate a serial time-domain baseband signal. The serial-to-parallel block 265 converts the time-domain baseband signal to parallel time domain signals. The size N FFT block 270 performs an FFT algorithm to generate N parallel frequency-domain signals. The parallel-to-serial block 275 converts the parallel frequency-domain signals to a sequence of modulated data symbols. The channel decoding and demodulation block 280 demodulates and decodes the modulated symbols to recover the original input data stream.

Each of the eNBs 101-103 may implement a transmit path 200 that is analogous to transmitting in the downlink to UEs 111-116 and may implement a receive path 250 that is analogous to receiving in the uplink from UEs 111-116. Similarly, each of UEs 111-116 may implement a transmit path 200 for transmitting in the uplink to eNBs 101-103 and may implement a receive path 250 for receiving in the downlink from eNBs 101-103.

Each of the components in FIGS. 2A and 2B can be implemented using only hardware or using a combination of hardware and software/firmware. As a particular example, at least some of the components in FIGS. 2A and 2B may be implemented in software, while other components may be implemented by configurable hardware or a mixture of software and configurable hardware. For instance, the FFT block 270 and the IFFT block 215 may be implemented as configurable software algorithms, where the value of size N may be modified according to the implementation.

Furthermore, although described as using FFT and IFFT, this is by way of illustration only and should not be construed to limit the scope of this disclosure. Other types of transforms, such as Discrete Fourier Transform (DFT) and Inverse Discrete Fourier Transform (IDFT) functions, could be used. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIGS. 2A and 2B illustrate examples of wireless transmit and receive paths, various changes may be made to FIGS. 2A and 2B. For example, various components in FIGS. 2A and 2B could be combined, further subdivided, or omitted and additional components could be added according to particular needs. Also, FIGS. 2A and 2B are meant to illustrate examples of the types of transmit and receive paths that could be used in a wireless network. Any other suitable architecture could be used to support wireless communications in a wireless network.

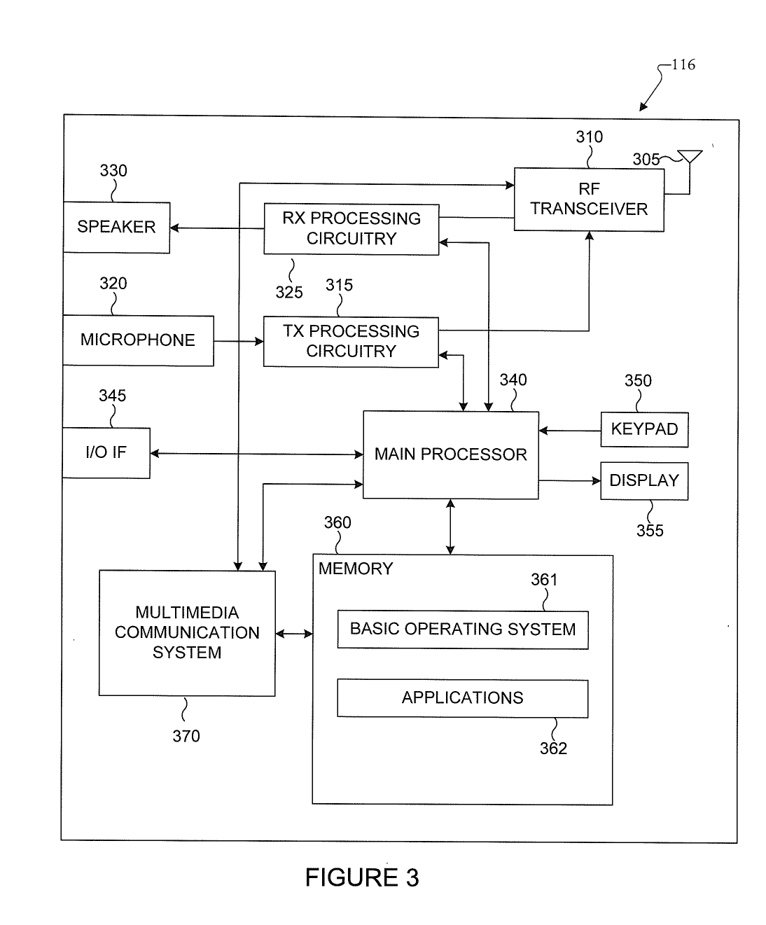

FIG. 3 illustrates an example UE 116 according to this disclosure. The embodiment of the UE 116 illustrated in FIG. 3 is for illustration only and one or more of the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes an antenna 305, a radio frequency (RF) transceiver 310, transmit (TX) processing circuitry 315, a microphone 320, and receive (RX) processing circuitry 325. The UE 116 also includes a speaker 330, a main processor 340, an input/output (I/O) interface (IF) 345, a keypad 350, a display 355, a memory 360, and a multimedia communication system 370. The memory 360 includes a basic operating system (OS) program 361 and one or more applications 362.

The RF transceiver 310 receives, from the antenna 305, an incoming RF signal transmitted by an eNB of the network 100. The RF transceiver 310 down-converts the incoming RF signal to generate an intermediate frequency (IF) or baseband signal. The IF or baseband signal is sent to the RX processing circuitry 325, which generates a processed baseband signal by filtering, decoding, and/or digitizing the baseband or IF signal. The RX processing circuitry 325 transmits the processed baseband signal to the speaker 330 (such as for voice data) or to the main processor 340 for further processing (such as for web browsing data).

The TX processing circuitry 315 receives analog or digital voice data from the microphone 320 or other outgoing baseband data (such as web data, e-mail, or interactive video game data) from the main processor 340. The TX processing circuitry 315 encodes, multiplexes, and/or digitizes the outgoing baseband data to generate a processed baseband or IF signal. The RF transceiver 310 receives the outgoing processed baseband or IF signal from the TX processing circuitry 315 and up-converts the baseband or IF signal to an RF signal that is transmitted via the antenna 305.

The main processor 340 can include one or more processors or other processing devices and execute the basic OS program 361 stored in the memory 360 in order to control the overall operation of the UE 116. For example, the main processor 340 could control the reception of forward channel signals and the transmission of reverse channel signals by the RF transceiver 310, the RX processing circuitry 325, and the TX processing circuitry 315 in accordance with well-known principles. In some embodiments, the main processor 340 includes at least one microprocessor or microcontroller.

The main processor 340 is also capable of executing other processes and programs resident in the memory 360, such as operations associated with the multimedia communication system 370 such as transmitting requests for name-based media delivery, receiving the name-based media, configuring the name-based media, and presenting the name-based media via the UE 116. The multimedia communication system 370 will be discussed further herein. The main processor 340 can move data into or out of the memory 360 as required by an executing process. In some embodiments, the main processor 340 is configured to execute the applications 362 based on the OS program 361 or in response to signals received from eNBs or an operator. The main processor 340 is also coupled to the I/O interface 345, which provides the UE 116 with the ability to connect to other devices such as laptop computers and handheld computers. The I/O interface 345 is the communication path between these accessories and the main controller 340.

The main processor 340 is also coupled to the keypad 350 and the display unit 355. The operator of the UE 116 can use the keypad 350 to enter data into the UE 116. The display 355 may be a liquid crystal display or other display capable of rendering text and/or at least limited graphics, such as from web sites.

The memory 360 is coupled to the main processor 340. Part of the memory 360 could include a random access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the main processor 340 could be divided into multiple processors, such as one or more central processing units (CPUs) and one or more graphics processing units (GPUs). Also, while FIG. 3 illustrates the UE 116 configured as a mobile telephone or smartphone, UEs could be configured to operate as other types of mobile or stationary devices.

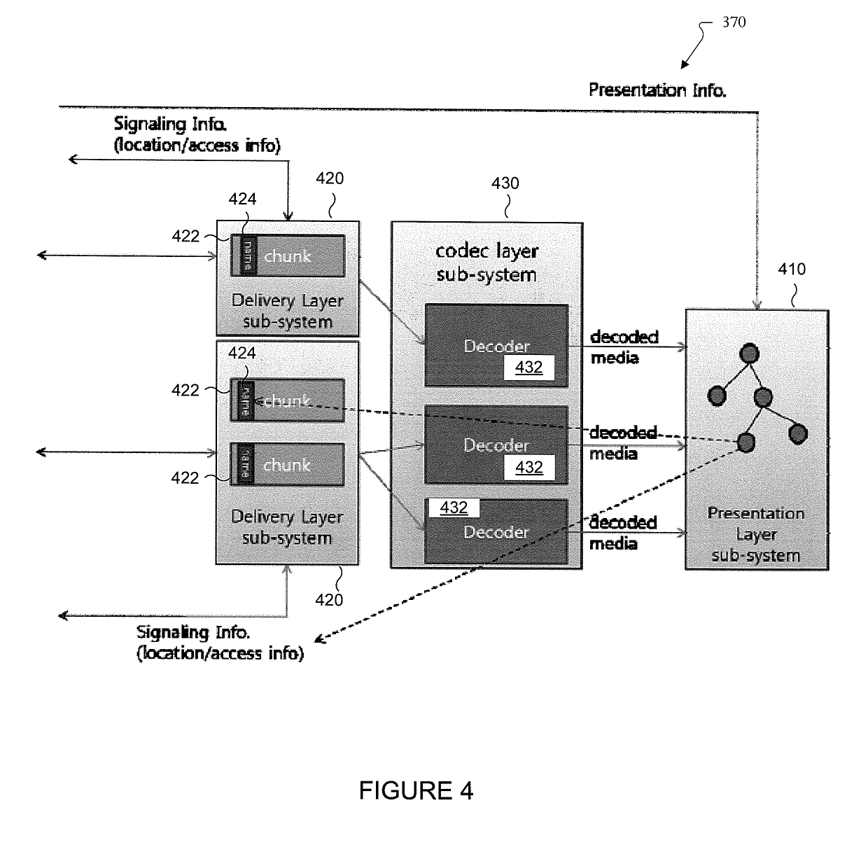

FIG. 4 illustrates an example configuration of a multimedia communication system 370 according to this disclosure. The embodiment of the multimedia communication system 370 shown in FIG. 4 is for illustration only. Other embodiments could be used without departing from the scope of the present disclosure.

The multimedia communication system 370 is configured to utilize a plurality of data connections of an electronic device to access or retrieve media as well as configure and present that media via one or more video output devices or audio output devices of the electronic device. Data connections can be communicatively linked to local storage in the electronic device or external storage accessed via wireless or wired connections. Data connections also can be communicatively linked to hardware implemented with a software based environment, which does not have restrictions regarding supporting various compression technologies and dynamic coding configuration changes. The multimedia communication system 370 includes an architecture that facilitates the delivery, configuration, and presentation of name-based media. The multimedia communication system 370 includes a presentation layer sub-system 410, one or more delivery layer sub-systems 420, and a codec layer sub-system 430.

The multimedia communication system 370 receives presentation information identifying multimedia associated with a name. For example, the multimedia communication system 370 can receive an input signal identifying a slide show presentation implementing an interactive video. The interactive video can be implemented with an HTML5 format. The interactive video is associated with a name, such as “interactive video presentation display.” The interactive video name also can be associated with the slide show presentation so that, for example, when the slide show presentation is initiated, the slide show presentation can provide an input signal to the multimedia communication system 370 to retrieve the interactive video associated with the name “interactive video presentation display.”

After the multimedia communication system 370 receives presentation information identifying multimedia associated with a name, the presentation layer sub-system 410 receives and processes the presentation information. The presentation layer sub-system 410 also transmits a message to the delivery layer sub-system 420 instructing the delivery layer sub-system 420 to request or retrieve multimedia data associated with the name. For example, after the presentation layer sub-system 410 receives the input signal identifying the slide show presentation implementing the interactive video associated with the name “interactive video presentation display,” the presentation layer sub-system 410 transmits a request to the delivery layer sub-system 420 to retrieve multimedia data associated with the name “interactive video presentation display.”

After the delivery layer sub-system 420 receives the message with the instruction to request or retrieve multimedia data associated with the name, the delivery layer sub-system 420 utilizes signaling information to establish connections with one or more data stores to obtain the multimedia data. For example, the delivery layer sub-system 420 can transmit a request to a signaling information server 150 for signaling information for one or more name-based multimedia data units. The signaling information includes at least the name of the multimedia data, one or more locations where the multimedia data is stored, and one or more methods or channels by which the delivery layer sub-system 420 can retrieve or access the multimedia data. As previously discussed, the signaling information server 150 can transmit the signaling information to the delivery sub-system 420 in response to receiving a request for signaling information or the signaling information server 150 can intermittently or continuously transmit a signaling information index to the UE as the signaling information server 150 generates updates to the signaling information index so that the UE has the signaling information available to obtain to the name-based multimedia even before receiving a request for name-based multimedia.

Once the delivery layer sub-system 420 obtains the signaling information related to name-based multimedia data, the delivery layer sub-system 420 establishes a connection with one or more data stores using signaling information in order to obtain the name-based multimedia data associated with a particular name. The layer sub-system 420 identifies one or more channels to one or more locations to obtain the name-based multimedia using the signaling information and identifies the multimedia data in one or more identified locations (such as servers or storage devices) based on a name provided with the name-based multimedia. For example, the multimedia data includes a label or indication 424 associating multimedia data with a particular name. The delivery layer sub-system 420 can access one or more data stores, identify the multimedia data associated with the name based on the indication 424 and obtain the name-based multimedia data associated with the particular name.

The delivery layer sub-system 420 can receive name-based multimedia data in chunks 422 with each chunk 422 associated with the particular name 424. The multimedia communication system 370 configures the one or more chunks of name-based multimedia data for presentation. For example, the delivery layer sub-system 420 forwards the chunks 422 to a codec layer sub-system 430. The codec layer sub-system 430 instantiates appropriate decoders with the name-based multimedia in the chunk 422. The codec layer sub-system 430 also initializes the decoders based on initialization information stored in the chunk 422. Decoded multimedia data is subsequently delivered to the presentation layer sub-system 410 for presentation through the UE. The decoded multimedia is linked to presentation layer sub-system 410 with based on the name of the multimedia. The system discussed herein can be implemented with MPEG Media Transport. The UE and system architecture can also be aligned with Information Centric Networking (ICN).

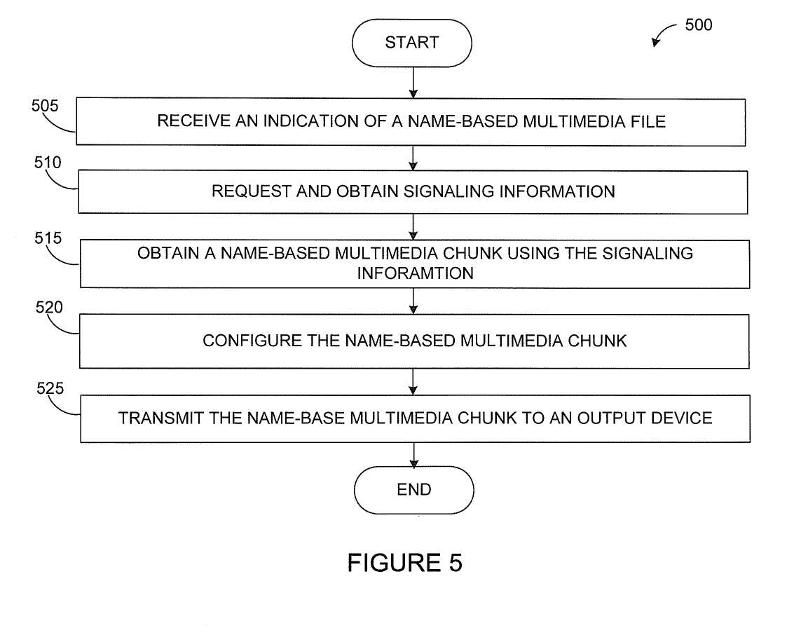

FIG. 5 illustrate a flow diagram of an example method 500 according to this disclosure. While the flow chart depicts a series of sequential steps, unless explicitly stated, no inference should be drawn from that sequence regarding specific order of performance, performance of steps or portions thereof serially rather than concurrently or in an overlapping manner, or performance of the steps depicted exclusively without the occurrence of intervening or intermediate steps. The process depicted in the example depicted is implemented by a transmitter chain in, for example, a mobile station.

At step 505, the multimedia communication system 370 receives presentation information indicating a particular name-based multimedia file. At step 510, the multimedia communication system 370 requests and obtains signaling information providing information related to the name-based multimedia file. At step 515, the multimedia communication system 370 obtains one or more name-based multimedia chunks 422 of the name-based multimedia file using the signaling information. At step 520, the multimedia communication system 370 configures the one or more name-based multimedia chunks 422 for presentation. For example, the multimedia communication system 370 decodes the one or more name-based multimedia chunks 422. At step 525, the multimedia communication system 370 can transmit the decoded one or more name-based multimedia chunks 422 to an output device to output the content of the one or more name-based multimedia chunks 422.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. An electronic device comprising:
a media communication system configured to:
receive presentation information identifying a multimedia name;
receive one or more multimedia data units associated with the multimedia name; and
configure the one or more multimedia data units associated with the multimedia name for a presentation.

2. The electronic device of claim 1, wherein the media communication system is further configured to receive signaling information to establish one or more connections with one or more data stores in order to receive the one or more multimedia data units.

3. The electronic device of claim 2, wherein the signaling information comprises the multimedia name, the locations of the one or more multimedia data units, and the communication channels for receiving the one or more multimedia data units.

4. The electronic device of claim 2, wherein the media communication system is configured to receive the signaling information at regular intervals from one or more sources.

5. The electronic device of claim 2, wherein the media communication system is configured to retrieve the signaling information from one or more sources in response to receiving the presentation information.

6. The electronic device of claim 1, wherein the one or more multimedia data units are received from one or more data stores dedicated to the electronic device.

7. The electronic device of claim 1, wherein the media communication system implements MPEG Media Transport.

8. A media communication system of an electronic device, the system comprising:
a presentation layer configured to receive presentation information and configure multimedia data units for a presentation, wherein the presentation information identifies a multimedia name;
a delivery layer configured to receive one or more multimedia data units associated with the multimedia name; and
a codec layer configured to decode the one or more multimedia data units received by the delivery layer before the multimedia data units are configured for the presentation.

9. The system of claim 8, wherein the delivery layer is further configured to receive signaling information to establish one or more connections with one or more data stores in order to receive the one or more multimedia data units.

10. The system of claim 9, wherein the signaling information comprises the multimedia name, the locations of the one or more multimedia data units, and the communication channels for receiving the one or more multimedia data units.

11. The system of claim 9, wherein the delivery layer is configured to receive the signaling information at regular intervals from one or more sources.

12. The system of claim 9, wherein the delivery layer is configured to retrieve the signaling information from one or more sources in response to receiving the presentation information.

13. The system of claim 8, wherein the one or more multimedia data units are received from one or more data stores dedicated to the electronic device.

14. The system of claim 8, wherein the media communication system implements MPEG Media Transport.

15. A method for use in an electronic device, the method comprising:
receiving presentation information identifying a multimedia name;
receiving one or more multimedia data units associated with the multimedia name; and
configuring the one or more multimedia data units associated with the multimedia name for a presentation.

16. The method of claim 15, further comprising receiving signaling information to establish one or more connections with one or more data stores in order to receive the one or more multimedia data units.

17. The method of claim 16, wherein the signaling information comprises the multimedia name, the locations of the one or more multimedia data units, and the communication channels for receiving the one or more multimedia data units.

18. The method of claim 16, wherein the signaling information is received at regular intervals from one or more sources.

19. The method of claim 16, wherein receiving the signaling information comprises retrieving the signaling information from one or more sources in response to receiving the presentation information.

20. The method of claim 15, wherein the one or more multimedia data units are received from one or more data stores dedicated to the electronic device.

21. The method of claim 15, wherein the media communication system implements MPEG Media Transport.
